(19) United States
(12) Patent Application Publication
(10) Pub. No.: US 2007/0191975 A1
(43) Pub. Date: Aug. 16, 2007

(54) Secure content delivery device

(75) Inventor: Charles J. Valosen, New Market, AL (US)

Correspondence Address: LOZA & LOZA, 305 N. Second Avenue, #127, Upland, CA, 91786-6064, US

(73) Assignee: Sanmina-SCI, a Delaware Corporation, San Jose, CA (US)

(21) Appl. No.: 11/336,059

(22) Filed: Jan. 20, 2006

(51) Int. Cl. G06F 17/00

(52) U.S. Cl. 700/94

(57) ABSTRACT

A small form-factor electronic device is provided which is configured to store audio, text, and/or video content and control delivery of such content from a user interface on the electronic device. Such device may be coupled to an audio/visual playback device to receive and output the delivered content to users. The electronic device may also provide a security mechanism that inhibits unauthorized copying of the content stored in the electronic device. The electronic device may provide a convenient way for storing and/or delivering publications (e.g., books, articles, printed news, etc.) in audio and/or text form.

### FIELD

Various embodiments of the invention pertain to mobile electronic devices for securely storing data and content. More specifically, at least one embodiment provides an apparatus and method for delivering audio and/or visual content device in a small form-factor electronic device that secures access to the content and delivers the content through an external playback device.

### BACKGROUND

Multimedia content, including audio, text, and/or video content, is commonly stored in electromagnetic media (e.g., tape, etc.) and/or electro-optical media (compact discs, etc.). However, such media storage typically lack features to inhibit unauthorized copying of the content stored therein.

Many types of digital audio playback devices that are capable of storing audio content (including audio books, music, etc.) and playing it back. Typically, these devices include a power source (e.g., batteries), an interface to download content into the playback device, and circuitry to store and/or playback the audio content. A computer is commonly coupled to a playback device to download content from the computer to the playback device. However, in situations where a computer is unavailable, users are often unable to load new content into the playback device.

### SUMMARY

Various aspects of the present invention may provide a small form-factor electronic device for securely storing and delivering stored content and controlling content delivery from a user interface on the electronic device. The electronic device may be a portable apparatus and include (a) a storage device to store content, (b) an output interface to couple the portable apparatus to a playback device, (c) a user interface to control delivery of the content through the output interface, and (d) a processing circuit coupled to the storage device, the user interface, and output interface. The processing unit may be configured to (1) securely store the content, and (2) deliver the stored content through the output interface according to the controls from the user interface. The user interface may include one or more buttons to initiate, pause, stop, and/or fast forward and/or reverse delivery of the content. The playback device may be an external apparatus that serves as an output for the delivered content. The stored content may include audio, text, and/or video content. For instance, the stored content may be a book stored in both audio and text formats. The content may be delivered as both audio signals and text signals. The electronic device may cause a secure application to be executed on the playback device to output the delivered content. The storage device may be a removable device that can be swapped with different storage devices with different pre-stored read-only content. An input interface in the electronic device may provide a way to receive power from an external power source.

Another embodiment of the invention provides a method for securely storing and delivering content from a small form-factor electronic device. The content to be delivered is selected from a portable electronic device and delivered in a secured (e.g., encrypted) manner to an external playback device. An integrated user interface may enable a user to control delivery of the content from the electronic device. The content may be encrypted for security against unauthorized copying and/or distribution. The portable electronic device may trigger a secure application to be executed on the playback device to output the delivered content when the portable electronic device is coupled to the playback device.

### BRIEF DESCRIPTION OF THE DRAWINGS

FIG. 1 is a block diagram illustrating how a content delivery device may be coupled to a playback device according to one embodiment of the invention.

FIG. 2 is a block diagram of a content delivery device according to one embodiment of the invention.

FIG. 3 is a perspective view of a content delivery device according to one embodiment of the invention.

FIG. 4 is a flow diagram illustrating a method for securely delivering content to a playback device according to one embodiment of the invention.

### DETAILED DESCRIPTION

In the following description numerous specific details are set forth in order to provide a thorough understanding of the invention. However, one skilled in the art would recognize that the invention might be practiced without these specific details. In other instances, well known methods, procedures, and/or components have not been described in detail so as not to unnecessarily obscure aspects of the invention.

In the following description, specific details are given to provide a thorough understanding of the embodiments. However, it will be understood by one of ordinary skill in the art that the embodiments may be practiced without these specific detail. For example, circuits or processes may be shown in simplified diagrams in order not to obscure the embodiments in unnecessary detail. In other instances, well-known circuits, structures, processes and techniques may not be described in detail so as not to obscure the embodiments.

One feature of the invention provides a small form-factor electronic device capable of storing audio, text, and/or video content and configured to control delivery of such content. Such device may be coupled to a playback device to deliver the content to users. The electronic device also provides a security mechanism that inhibits unauthorized copying of the content stored in the electronic device. Another aspect of the invention provides a convenient way for storing and/or delivering publications (e.g., books, articles, printed news, etc.) in audio and/or text form.

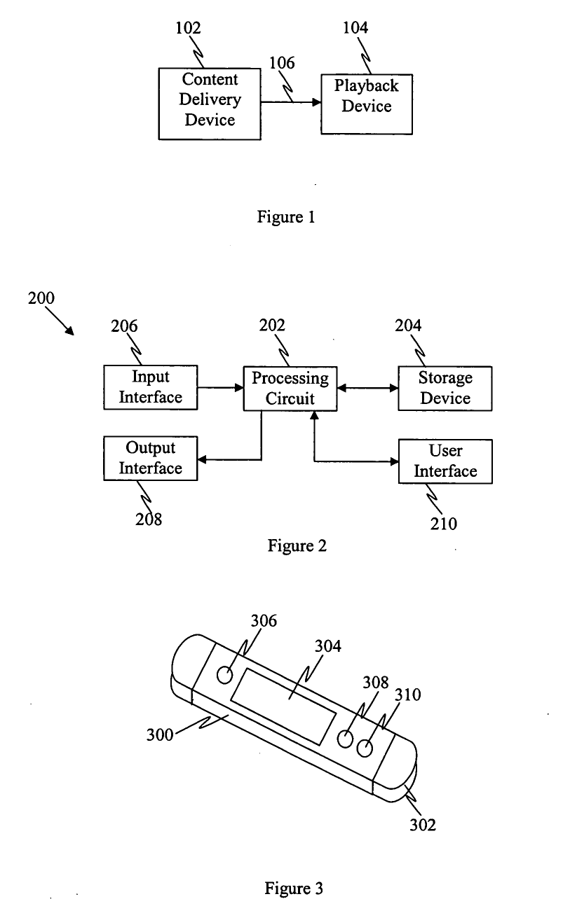

FIG. 1 is a block diagram illustrating how a content delivery device 102 may be coupled to a playback device 104 according to one embodiment of the invention. The content delivery device 102 may store audio, text, data, and/or video content in analog or digital form. The content delivery device 102 may be pre-loaded into read-only memory or loaded on demand into static memory. The content may also be secured to inhibit unauthorized copying and/or tampering.

The content delivery device 102 may be coupled to a playback device 104 to deliver (e.g., play or show) the content in the delivery device 102 to a user. The playback device 104 may play audio content or display video or text content from the device 102. In various embodiments, the playback device 102 may be a digital music player (e.g., MP3 player, etc.), a computer, a personal digital assistant (e.g., PDA, etc.) or other audio, video, and/or text playback devices.

In one implementation, the content delivery device 102 may control the delivery of the content to the playback device 104. For instance, various modes for delivering (e.g., playing, showing, or delivering) content from the content delivery device 102 may be controlled by software, devices, and/or interfaces on the content delivery device 102. This may minimize the amount of access or control available to the playback device 104 over the content, thereby inhibiting unauthorized access or copying of the content. For instance, when coupled to the playback device 102, the content delivery device 102 may trigger a secure playback application to be executed. This application may be executed on the content delivery device 102 and/or on the playback device 104. The content delivery device 102 may also determine a level of security employed depending on the type of playback device to which it is coupled.

Various types of content delivery interfaces or links 106 may be used between the content delivery device and the playback device 104. For instance, the link 106 may be a universal serial bus (USB) interface, an infrared interface, a wireless interface, or other data delivery interface. In various implementations, the link 106 may be used for delivering content to and from the content delivery device 102.

FIG. 2 is a block diagram of a content delivery device 200 according to one embodiment of the invention. The content delivery device 200 may include a processing circuit 202 coupled to a storage device 204, an input interface 206, an output interface 208, and a user interface 210. The processing circuit 202 may include one or more processing circuits, logic devices, switches, and/or electronic circuits configured to retrieve stored content from the storage device 204, store content into the storage device 204, and/or secure the content in the storage device 204 against unauthorized copying. The storage device 204 may be read-only memory or static memory to which content (e.g., audio, text, video, etc.) can be added and/or removed by a user. In various implementations, the storage device 204 maybe an integral component or a removable component (e.g., memory card, sans disks, etc.). The processing unit 202 may receive commands, data requests, and/or new content through the input interface 206. Stored content may be delivered by the content delivery device 200 in analog and/or digital form through the output interface 208. The input and/or output interface 208 may be a universal serial bus (USB) interface, an infrared interface, a wireless interface, or other type of communication interface(s). For example, where a wireless interface is used, it may implement a standard protocol, such as Bluetooth, for delivery of the content to a user via a headset. The user interface 210 is coupled to the processing circuit 202 and provides buttons and/or displays to permit a user to select the content for delivery, initiate content delivery, fast forward and/or reverse content being delivered, pause and/or stop content delivery, select a delivery mode, etc.

According to another feature of the invention, the content delivery device 200 may be powered by an internal power source (e.g., battery) or an external power source through the input interface 206.

FIG. 3 is a perspective view of a content delivery device 300 according to one embodiment of the invention. The content delivery device 300 may have a compact form-factor for ease of carrying, for example, it may be in the form of a short stick. In one implementation, the device 300 may include one or more of the components illustrated in FIG. 2 and is configured to store content and securely deliver it. To achieve such security the content delivery device may encrypt the stored content for storage and/or delivery.

A communication interface may be located at a first end 302 of the content delivery device 300 to couple the device 300 to a playback device. One or more buttons 306, 308, and 310 may permit a user to control delivery of the content. For example, a first button 306 may permit a user to select between various modes of operation, such as audio content delivery only, text content delivery only, video content delivery only, mixed content delivery, which interface to use for delivery, etc. Another set of buttons 308 and 310 may enable a user to scroll up/down between different content choices. An integrated display 304 may provide a user menu, show titles of the content stored in the content delivery device 300, and display other information to the user. This may permit a user to scroll through content titles (e.g., books, articles, magazines, music, movies, etc.) stored in the device 300 and select the desired content. In one implementation, a user may select a desired content for delivery by pressing a button on the device 300.

The buttons 306 and 308 may have dual or multiple uses. For example, in a first mode of operation (e.g., as when content is not being delivered), the buttons may permit a user to scroll through content stored in the device 300, while in a second mode of operation (e.g., as when content is already being delivered) the buttons may be used to fast forward or reverse the content being delivered. Similarly, the mode button 306 may have dual purposes where in a first mode of operation (e.g., as when content is not being delivered) it may select a playback mode (e.g., audio content only, etc.) and in a second mode of operation (e.g., as when content is being delivered) it may be used to stop, pause, and/or resume playing/delivering content.

Through the user interfaces 305, 306, 308, and 310 and internal configurations, the content delivery device 300 controls delivery and/or access to the content stored therein. Specifically, the content in the content delivery device 300 is not retrieved by the playback device, but instead sent by the delivery device 300. Thus, content delivery and security is controlled by the content delivery device 300 not the playback device. This feature is in contrast to the prior art where playback devices retrieve content for a storage medium. For example, the content deliver device 300 may cause a specific secure application to execute on the playback device to receive and playback the content delivered by the content delivery device 300. In another implementation, the content delivery device 300 may execute a playback application internally and delivery just audio signals and/or display signals to the playback device. Thus, the playback device is used as a mere output device with minimal processing of the content except for output purposes.

According to one feature of the invention, the content delivery device 300 may deliver text content through an output interface to a playback device and/or display the text content on the built-in display 304 so a user can readily read scrolling text content. Additionally, the content delivery device 300 may also deliver audio content via the output interface and/or via a built-in speaker.

Another feature of the invention provides for delivering both audio and text content together from the content delivery device. For example, the content may include a book or article in both audio and text formats. This enables several different implementations for the content delivery device 300. For instance, the content delivery device 300 may serve as a reading teaching tool or a foreign language learning tool by having a playback device display the text content while the associated audio content is played.

In some implementations, the content delivery device 300 or playback device may generate audio signals by using a text-to-audio converter. In this way, it is not necessary to store the same content in various formats.

In other embodiments, the content delivery device 300 may be used in karaoke applications, where audio music for a song and the text words to song are delivered together so users can sign along.

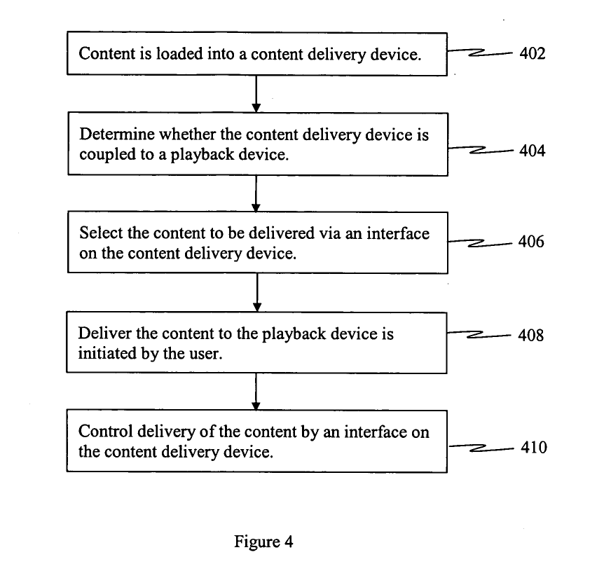

FIG. 4 is a flow diagram illustrating a method for securely delivering content to a playback device according to one embodiment of the invention. Content is loaded into a content delivery device 402. In various implementations, the content may be loaded by the manufacturer of the content delivery device into a read-only memory device, loaded by a user of the content delivery device, and/or loaded by a dispensing machine from where a user may purchase content. The content delivery device then determines when it is coupled to a playback device 404. A user may select the content to be delivered by an interface on the content delivery device 406. The user then initiates delivery of the content to the playback device 408. Such delivery of content may be done in a secure way such as to inhibit unauthorized access and/or copying of the content. Delivery of the content is controlled by an interface on the content delivery device 410. This may be done by one or more play, pause, stop, forward, reverse buttons on the content delivery device.

One or more of the components and functions illustrated in FIGS. 1, 2, and/or 3 may be rearranged and/or combined into a single component or embodied in several components without departing from the invention. Additional elements or components may also be added without departing from the invention. The apparatus, devices, and/or components illustrated in FIGS. 1, 2, and/or 3 may be configured to perform the methods, features, or steps illustrated in FIG. 4 and/or 6.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications are possible. Those skilled, in the art will appreciate that various adaptations and modifications of the just described preferred embodiment can be configured without departing from the scope and spirit of the invention. Therefore, it is to be understood that, within the scope of the appended claims, the invention may be practiced other than as specifically described herein.

What is claimed is:

1. A small form-factor portable apparatus comprising:
a storage device to store content;
an output interface to couple the portable apparatus to a playback device;
a user interface to control delivery of the content through the output interface;
a processing circuit coupled to the storage device, the user interface, and output interface and configured to securely store the content, and
deliver the stored content through the output interface according to the controls from the user interface.

2. The portable apparatus of claim 1 wherein the user interface can initiate, pause, and stop delivery of the content.

3. The portable apparatus of claim 1 wherein the user interface can fast forward or reverse delivery of the content.

4. The portable apparatus of claim 1 wherein the playback device is an external apparatus that serves as an output for the delivered content.

5. The portable apparatus of claim 1 wherein the content includes at least one of audio and text content.

6. The portable apparatus of claim 1 wherein the delivered content is a book stored in both audio and text formats.

7. The portable apparatus of claim 1 wherein the content is delivered as at least one of audio signals and text signals.

8. The portable apparatus of claim 1 wherein the content is encrypted.

9. The portable apparatus of claim 1 wherein the user interface include one or more buttons to control delivery of the content and a display.

10. The portable apparatus of claim 1 wherein the processing circuit is further configured to cause a secure application to be executed on the playback device to output the delivered content.

11. The portable apparatus of claim 1 wherein the storage device is a removable device and can be swapped with different storage devices with different pre-stored read-only content.

12. The portable apparatus of claim 1 further comprising:
an input interface to receive power from an external power source.

13. The portable apparatus of claim 1 further comprising:
a small form-factor body to house the storage device, the output interface, the user interface, and the processing circuit.

14. A content delivery apparatus comprising:
means for securely storing content;
means for sending the stored content to an external playback device; and
means for controlling delivery of the stored content according to integrated user controls.

15. The content delivery apparatus of claim 14 wherein the integrated user controls can initiate, pause, and stop delivery of the content.

16. The content delivery apparatus of claim 14 wherein the integrated user controls can fast forward or reverse delivery of the content.

17. The content delivery apparatus of claim 14 wherein the stored content is delivered in both audio and text formats.

18. A method for securely storing and delivering content comprising:
selecting content to be delivered from a portable electronic device;
delivering content in a secured manner to an external playback device; and
controlling delivery of the content according to integrated user controls on the portable electronic device.

19. The method of claim 17 further comprising:
encrypting the content with an encryption algorithm; and
loading the content in the portable electronic device.

20. The method of claim 17 further comprising:
triggering a secure application to be executed on the playback device to output the delivered content.
